(19) United States
(12) Patent Application Publication
(10) Pub. No.: US 2026/0100311 A1
(43) Pub. Date: Apr. 9, 2026

(54) METHOD FOR MANUFACTURING MULTILAYER CERAMIC ELECTRONIC COMPONENT AND MULTILAYER CERAMIC ELECTRONIC COMPONENT

(71) Applicant: TAIYO YUDEN CO., LTD., Tokyo (JP)

(72) Inventor: Hideya TERAOKA, TOKYO (JP)

(21) Appl. No.: 19/114,866

(22) PCT Filed: Jul. 10, 2023
(86) PCT No.: PCT/JP2023/025438

§ 371 Date: Mar. 25, 2025

(30) Foreign Application Priority Data
Sep. 26, 2022 (JP) 2022-152836

(51) Int. Cl. H01G 4/30; H01G 4/005; H01G 4/12; H01G 4/232

(52) U.S. Cl. CPC H01G 4/306; H01G 4/005; H01G 4/232; H01G 4/12

(57) ABSTRACT

The method for manufacturing a multilayer ceramic electronic component 1 includes a step of forming a discontinuous internal electrode pattern 6 having gaps Dv on a dielectric green sheet by using a vacuum film formation method, a step of stacking and applying pressure bonding to a plurality of dielectric green sheets such that the internal electrode patterns 6 overlap each other, a step of dividing the plurality of dielectric green sheets that have been bonded, into a plurality of laminates 2, and a step of firing the laminates 2 such that widths Lv of the gaps Dv shrink.

### TECHNICAL FIELD

The present invention relates to a method for manufacturing a multilayer ceramic electronic component and a multilayer ceramic electronic component.

### BACKGROUND ART

Multilayer ceramic electronic components such as multilayer ceramic capacitors have a laminated chip in which internal electrode layers and dielectric layers are alternately stacked. For example, in response to the demand for smaller electronic components and larger capacity, multilayer ceramic capacitors have become widespread in which the number of layers is increased without changing the volume of the ceramic element assembly by reducing thicknesses of the internal electrode layers. For example, PTL 1 describes a method for forming a thin internal electrode pattern by sputtering.

### CITATION LIST

### Patent Literature

[PTL 1]

JP 2021-64637A

### SUMMARY

### Technical Problem

However, when the internal electrode patterns become thinner, there is a risk that cracks will occur in the internal electrode patterns due to stress caused by shrinkage of the ceramic element assembly during sintering in the manufacturing process of the multilayer ceramic capacitor.

Accordingly, the present invention has been made in consideration of the above problems, and has an object to provide a method for manufacturing a multilayer ceramic electronic component and a multilayer ceramic electronic component that can suppress the occurrence of cracks in internal electrode patterns.

### Solution to Problem

The method for manufacturing a multilayer ceramic electronic component of the present invention is characterized by including a step of forming a discontinuous internal electrode pattern having a gap on a dielectric green sheet by a vacuum film formation method, a step of stacking and applying pressure bonding to a plurality of the dielectric green sheets such that the internal electrode patterns overlap each other, a step of dividing the plurality of dielectric green sheets that have been bonded, into a plurality of laminates, and a step of firing the laminates such that the width of the gap is reduced.

In the step of forming the internal electrode pattern in the above manufacturing method, the gap may be formed to have a width of 20 μm or more.

In the step of forming the internal electrode pattern in the above manufacturing method, the gap may be formed to have a width of 15 μm or less.

In the step of forming the internal electrode pattern in the above manufacturing method, the gap may be formed so as to extend in two different directions.

In the step of forming the internal electrode pattern in the above manufacturing method, a conductor film thinner than the internal electrode pattern may be formed so as to fill the gap.

In the above manufacturing method, a thickness of the internal electrode pattern may be at least seven times a thickness of the conductor film.

In the above manufacturing method, the thickness of the internal electrode pattern may be equal to or less than 20 times the thickness of the conductor film.

In the step of forming the internal electrode pattern in the above manufacturing method, the internal electrode pattern may be formed by sputtering.

The multilayer ceramic electronic component of the present invention has a laminate including a plurality of dielectric layers and a plurality of internal electrode layers facing each other with the dielectric layers sandwiched therebetween, and a pair of external electrodes covering a pair of end faces of the laminate which face each other, respectively, and connected to the plurality of internal electrode layers alternately in a stacking direction of the laminate, and is characterized in that at least one of the plurality of internal electrode layers has one or more recesses or protrusions at a side end extending in the direction in which the pair of end faces face each other in a plan view viewed in the stacking direction.

The multilayer ceramic electronic component of the present invention has a laminate including a plurality of dielectric layers and a plurality of internal electrode layers facing each other with the dielectric layers sandwiched therebetween, and a pair of external electrodes covering a pair of end faces of the laminate which face each other, respectively, and connected to the plurality of internal electrode layers alternately in a stacking direction of the laminate, and is characterized in that at least one of the plurality of internal electrode layers has one or more recesses or protrusions at another end faced to an end connected to one of the pair of external electrodes in a plan view viewed in the stacking direction.

### Advantageous Effect of Invention

According to the present invention, the occurrence of cracks can be suppressed in the internal electrode patterns of a multilayer ceramic electronic component.

### BRIEF DESCRIPTION OF DRAWINGS

FIG. 1 is a perspective view illustrating an example of a multilayer ceramic capacitor.

FIG. 2 is a cross-sectional view of the multilayer ceramic capacitor taken along line A-A in FIG. 1.

FIG. 3 is a cross-sectional view of the multilayer ceramic Capacitor taken along line B-B in FIG. 1.

FIG. 4 is a cross-sectional view of a multilayer ceramic capacitor of a first embodiment taken along line C-C in FIG. 2.

FIG. 5 is a cross-sectional view of a multilayer ceramic capacitor of a second embodiment taken along line C-C in FIG. 2.

FIG. 6 s a cross-sectional view of a multilayer ceramic capacitor of a third embodiment taken along line C-C in FIG. 2.

FIG. 7 is a cross-sectional view of a multilayer ceramic capacitor of a fourth embodiment taken along line C-C in FIG. 2.

FIG. 8 is a flowchart illustrating an example of a manufacturing process for a multilayer ceramic capacitor.

FIG. 9 is a diagram illustrating an example of a dielectric green sheet 7 on which a mask corresponding to the internal electrode pattern of the first embodiment has been formed.

FIG. 10 is a cross-sectional view illustrating an example of how an internal electrode pattern is formed by sputtering.

FIG. 11 is a cross-sectional view illustrating the internal electrode pattern before firing and the internal electrode layer after firing in the first embodiment.

FIG. 12 is a plan view illustrating an example of a dielectric green sheet on which a mask corresponding to the internal electrode pattern of the second embodiment has been formed.

FIG. 13 is a cross-sectional view illustrating the internal electrode pattern before firing and the internal electrode layer after firing in the second embodiment.

FIG. 14 is a cross-sectional view illustrating the internal electrode pattern before firing and the internal electrode layer after firing in the third embodiment.

FIG. 15 is a cross-sectional view illustrating the internal electrode pattern before firing and the internal electrode layer after firing in the fourth embodiment.

FIG. 16 is a cross-sectional view illustrating an example of a method for forming conductive thin films in gaps.

### DESCRIPTION OF EMBODIMENTS

### First Embodiment

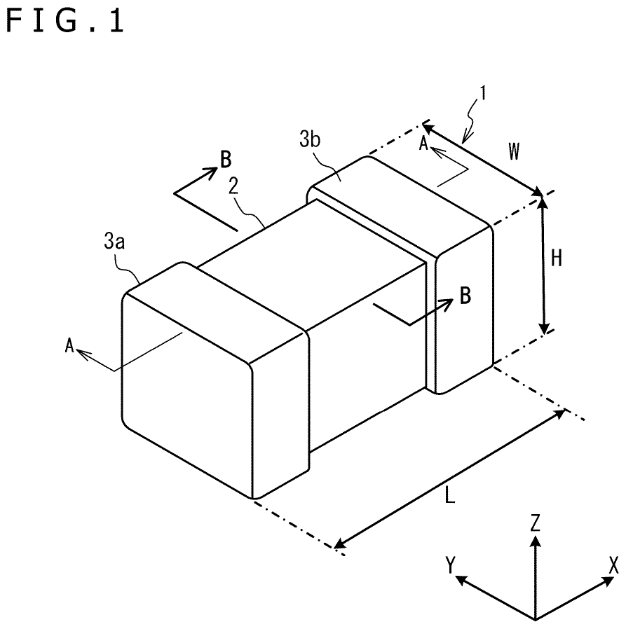

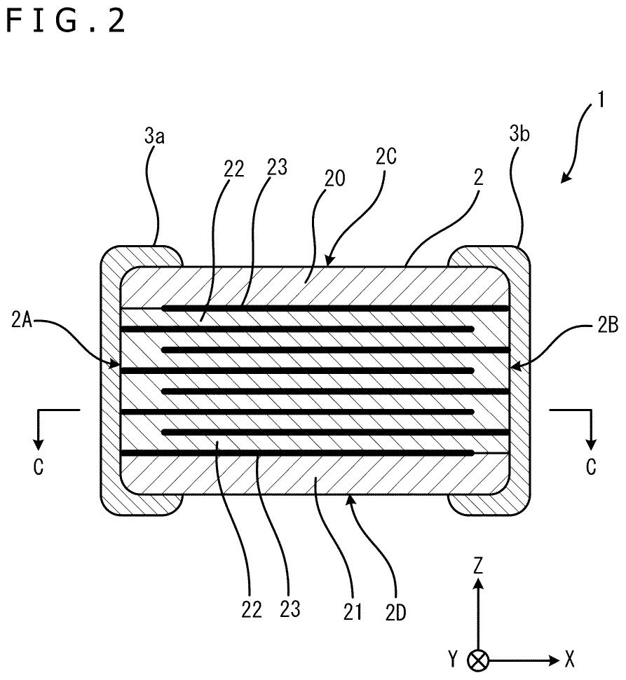

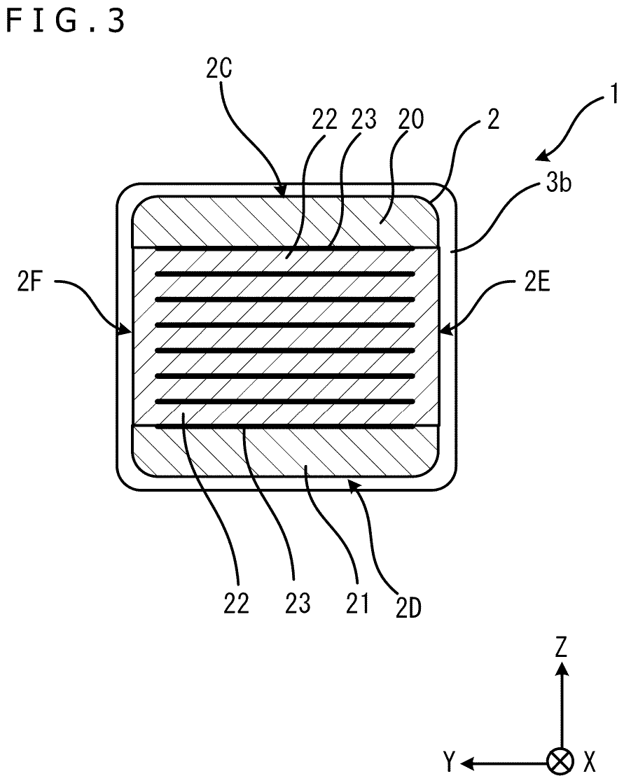

FIG. 1 is a perspective view illustrating an example of a multilayer ceramic capacitor 1. FIG. 2 is a cross-sectional view of the multilayer ceramic capacitor 1 taken along line A-A in FIG. 1. FIG. 3 is a cross-sectional view of the multilayer ceramic capacitor 1 taken along line B-B in FIG. 1. Note that FIGS. 1 to 3 illustrate shapes that are common to the other embodiments.

The multilayer ceramic capacitor 1 is an example of a multilayer ceramic electronic component. The multilayer ceramic capacitor 1 has a laminated chip 2 having a substantially rectangular parallelepiped shape, and external electrodes 3a and 3b provided on a pair of end faces 2A and 2B of the laminated chip 2 that face each other.

FIGS. 1 to 3 illustrate X, Y, and Z directions perpendicular to one another. The X direction is the longitudinal (L) direction of the multilayer ceramic capacitor 1, and coincides with the direction in which a pair of end faces of the laminated chip 2 face each other. The Y direction is the width (W) direction of the multilayer ceramic capacitor 1, and coincides with the direction in which a pair of side surfaces of the laminated chip 2 face each other. The Z direction is the height (H) direction of the multilayer ceramic capacitor 1, and coincides with the stacking direction of the multilayer ceramic capacitor 1.

The laminated chip 2 is an example of a laminate. The laminated chip 2 includes dielectric layers 22 containing a ceramic material that functions as a dielectric body and internal electrode layers 23 that are alternately stacked, and further includes a pair of cover layers 20 and 21 that are stacked such that the dielectric layers 22 and the internal electrode layers 23 are sandwiched therebetween from both sides in the stacking direction.

The cover layers 20 and 21 constitute an upper surface 2C and a lower surface 2D in the stacking direction of the laminated chip 2. In the laminated chip 2, one end of each internal electrode layer 23 in the longitudinal direction is drawn out to be exposed at the end face 2A or 2B alternately in the stacking direction.

The internal electrode layer 23 mainly includes a base metal such as Ni (nickel), Cu (copper), or Sn (tin). Noble metals such as Pt (platinum), Pd (palladium), Ag (silver), or Au (gold), or alloys containing these metals, may also be used for the internal electrode layer 23. The thickness of the internal electrode layer 23 is 0.1 to 0.3 (μm), for example.

The dielectric layer 22 has a main phase of a ceramic material having a perovskite structure represented by the general formula ABO₃, for example. Note that the perovskite structure includes ABO_{3-α}, which is not a stoichiometric composition. For example, the ceramic material can be selected from at least one of BaTiO₃ (barium titanate), CaZro₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr_{z}O₃ (0≤x≤1, 0≤y≤1, 0≤z≤1) that forms a perovskite structure, and other materials. Ba_{1-x-y}CaₓSr_{y}Ti_{1-z}Zr_{z}O₃ includes barium strontium titanate, barium calcium titanate, barium zirconate, barium titanate zirconate, calcium titanate zirconate, barium calcium titanate zirconate, etc. A thickness of the dielectric layer 22 is 1 (μm) or less, for example.

Further, the cover layers 20 and 21 are also formed mainly from a ceramic material, like the dielectric layer 22. The cover layers 20 and 21 each have a thickness of 10 to 15 (μm), for example.

The external electrodes 3a and 3b have a base film mainly including metals such as Cu, Ni, Al (aluminum), and Zn (zinc), or an alloy of two or more of these metals (e.g., an alloy of Cu and Ni), and contain ceramics such as a glass component for densifying the external electrodes 3a and 3b and a common material for controlling the sintering property of the external electrodes 3a and 3b. The glass component is an oxide of Ba (barium), Sr (strontium), Ca (calcium), Zn (zinc), Al, Si (silicon), B (boron), etc. The common material is a ceramic component mainly including the same material as the main component of the dielectric layer 22, for example. It is to be noted that, in the external electrodes 3a and 3b, a plating film mainly containing a base metal such as Ni, Cu, or Sn may be formed on the base film formed of the above metals. Furthermore, a film of conductive resin such as epoxy resin and urethane resin may be formed on the surface of the external electrodes 3a and 3b.

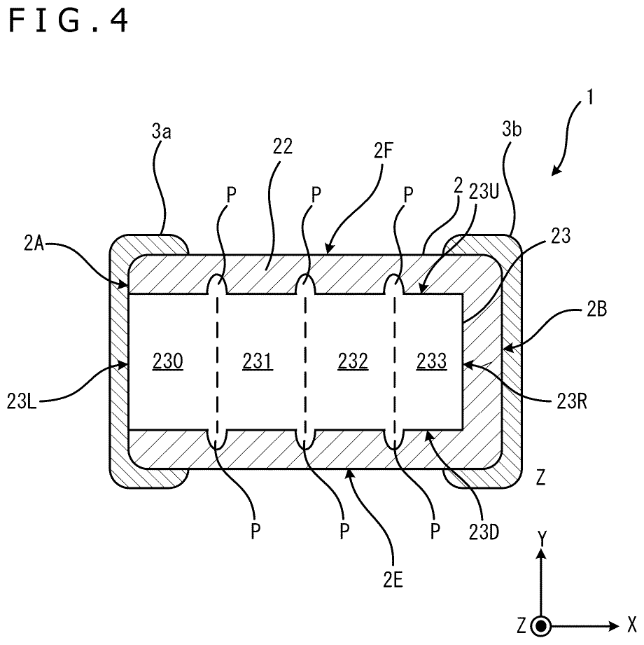

FIG. 4 is a cross-sectional view of the multilayer ceramic capacitor 1 according to the first embodiment taken along line C-C in FIG. 2. FIG. 4 illustrates the shape of the internal electrode layer 23 in a plan view viewed from the stacking direction. The internal electrode layer 23 has a substantially rectangular shape.

Among a pair of ends 23R and 23L of the internal electrode layer 23 which extend in the width direction of the multilayer ceramic capacitor 1, one end 23L is drawn to the end face 2A and connected to the external electrode 3a, whereas the other end 23R is not drawn to the end face 2B and is separated from the external electrode 3b. The external electrodes 3a and 3b are connected to the ends 23R and 23L of the internal electrode layer 23 alternately in the stacking direction.

The internal electrode layer 23 has protrusions P at each of side ends 23U and 23D extending in the longitudinal direction of the multilayer ceramic capacitor 1. As an example, the protrusions P are provided at both ends of the boundaries (see broken lines) of regions 230 to 233 that divide the internal electrode layer 23 into four in the longitudinal direction. The protrusions P on the side end 23U and the protrusions P on the side end 23D are substantially aligned in the longitudinal direction (X-axis) of the multilayer ceramic capacitor 1.

The protrusions P protrude toward side surfaces 2E and 2F of the laminated chip 2. The surface area of the internal electrode layers 23 is increased by the amount of the protrusions P compared to a case where the protrusions P are not present. Therefore, the facing areas of the internal electrode layers 23 facing each other in the stacking direction also increase, and thus the capacitance of the multilayer ceramic capacitor 1 increases. Incidentally, there is no limitation on the number and positions of the protrusions P on the side ends 23U and 23D.

The internal electrode layer 23 is formed as a discontinuous internal electrode pattern with gaps between the regions 230 to 233 by a vacuum film formation method such as sputtering. Thereafter, the laminated chip 2 shrinks during a firing step, thereby reducing the widths of the gaps between the regions 230 to 233, and the regions 230 to 233 are joined together and the portions pushed out in the width direction form the protrusions P. Incidentally, the method for manufacturing the multilayer ceramic capacitor 1 will be described in detail later.

### Second Embodiment

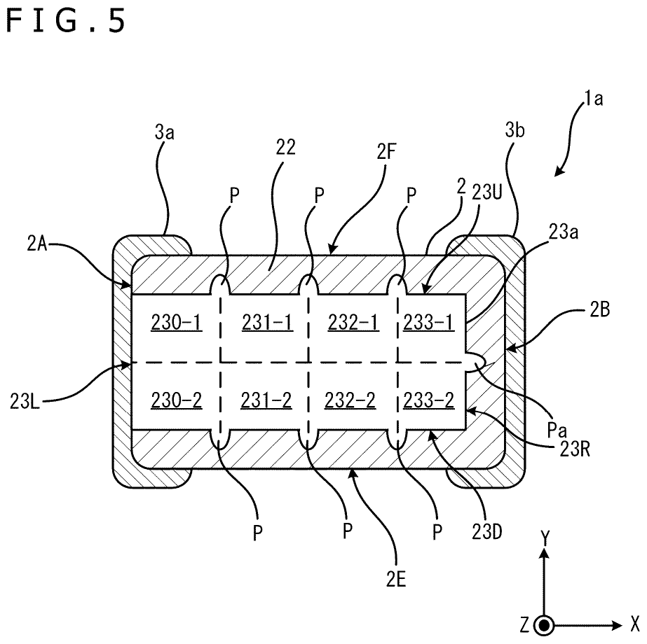

FIG. 5 is a cross-sectional view of a multilayer ceramic capacitor la according to a second embodiment taken along line C-C in FIG. 2. FIG. 5 illustrates the shape of an internal electrode layer 23a in a plan view viewed from the stacking direction. In FIG. 5, components common to those in FIG. 4 are given the same reference signs and their description is omitted. The internal electrode layer 23a has a substantially rectangular shape.

The internal electrode layer 23a has not only the protrusions P of the side ends 23U and 23D, but also a protrusion Pa at the end 23R faced to the end 23L connected to the external electrode 3a. As an example, the protrusions P and Pa are provided at positions corresponding to the boundaries (see broken lines) of the regions 230-1 to 233-1 and 230-2 to 233-2 obtained by dividing the internal electrode layer 23a into eight (4×2) parts in the longitudinal direction and width direction. The protrusion Pa on the end 23R is provided at one end of the boundary between the regions 230-1 to 233-1 on one side in the width direction and the regions 230-2 to 233-2 on the other side in the width direction.

The protrusion Pa protrudes toward the end face 2B of the laminated chip 2. Therefore, the surface area of the internal electrode layers 23a is increased compared to the first embodiment, and the capacitance of the multilayer ceramic capacitor la is increased. Note that there is no limitation on the number and positions of the protrusions Pa on the end 23R.

The internal electrode layer 23a is formed as a discontinuous internal electrode pattern with gaps between the regions 230-1 to 233-1, and 230-2 to 233-2 by a vacuum film formation method such as sputtering. Thereafter, the laminated chip 2 shrinks in the firing step, thereby reducing the widths of the gaps between the regions 230-1 to 233-1 and 230-2 to 233-2, and the regions 230-1 to 233-1 and 230-2 to 233-2 are joined together, so that the pushed-out portions in the width and longitudinal directions form the protrusions P and Pa, respectively. Note that the manufacturing method of the multilayer ceramic capacitor la will be described in detail later.

### Third Embodiment

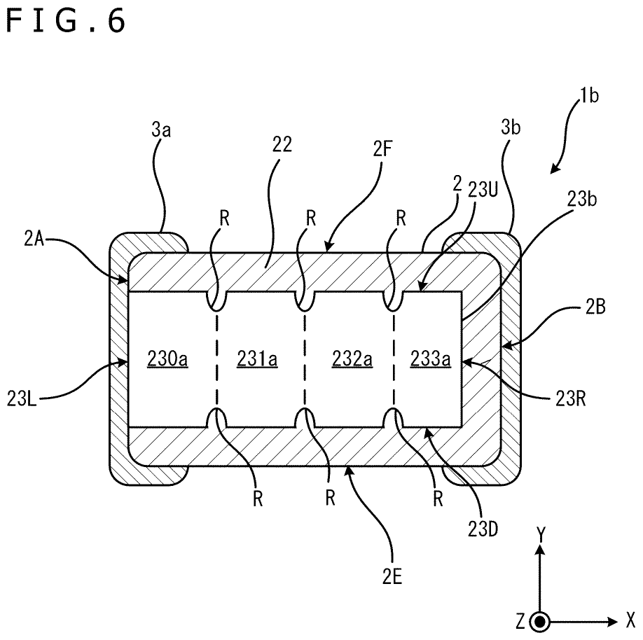

FIG. 6 is a cross-sectional view of a multilayer ceramic capacitor 1b according to a third embodiment taken along line C-C in FIG. 2. FIG. 6 illustrates the shape of an internal electrode layer 23b in a plan view viewed in the stacking direction. In FIG. 6, the components common to those in FIG. 4 are given the same reference signs, and their description will be omitted. The internal electrode layer 23b has a substantially rectangular shape.

The internal electrode layer 23b has recesses R at each of the side ends 23U and 23D extending in the longitudinal direction of the multilayer ceramic capacitor 1b. As an example, the recesses R are provided at both ends of the boundaries (see broken lines) between the regions 230a to 233a that divide the internal electrode layer 23b into four in the longitudinal direction. The recesses R on the side end 23U and the recesses R on the side end 23D are substantially aligned in the longitudinal direction (X-axis) of the multilayer ceramic capacitor 1b. Incidentally, there is no limitation on the number and positions of the recesses R on the side ends 23U and 23D.

In this way, since the recesses R are provided in the side ends 23U and 23D, the adhesion between the adjacent dielectric layers 22 in the stacking direction at the recesses R is improved, and peeling can be suppressed more effectively than in a configuration without the recesses R.

The internal electrode layer 23b is formed as a discontinuous internal electrode pattern with gaps between the regions 230a to 233a by a vacuum film formation method such as sputtering. The widths of the gaps are wider than those in the first and second embodiments. Thereafter, since the laminated chip 2 shrinks during the firing step, the widths of the gaps between the regions 230a to 233a are reduced, and the regions 230a to 233a are joined together. However, since the widths of the gaps are wide, the gaps are not completely filled, and gaps remain on the side ends 23U and 23D. The remaining gaps are formed as the recesses R. Note that the manufacturing method of the multilayer ceramic capacitor 1b will be described in detail later.

### Fourth Embodiment

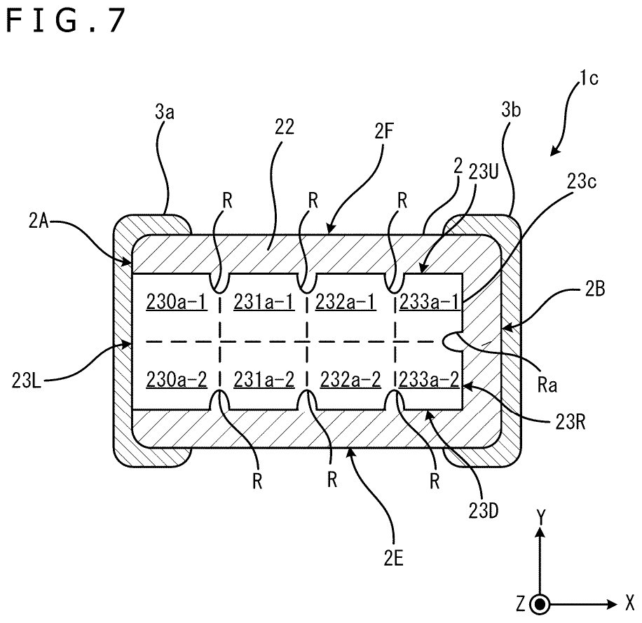

FIG. 7 is a cross-sectional view of a multilayer ceramic capacitor 1c according to a fourth embodiment taken along line C-C in FIG. 2. FIG. 7 illustrates the shape of an internal electrode layer 23c in a plan view viewed in the stacking direction. In FIG. 7, components common to those in FIG. 6 are given the same reference signs, and their description will be omitted. The internal electrode layer 23c has a substantially rectangular shape.

The internal electrode layer 23c has not only the recesses R of the side ends 23U and 23D, but also a recess Ra at the end 23R faced to the end 23L connected to the external electrode 3a. As an example, the recesses R and Ra are provided at positions corresponding to the boundaries (see broken lines) of the regions 230a-1 to 233a-1 and 230a-2 to 233a-2 obtained by dividing the internal electrode layer 23c into eight (4×2) in the longitudinal direction and width direction. The recess Ra on the end 23R is provided at one end of the boundary between the regions 230a-1 to 233a-1 on one side in the width direction and the regions 230a-2 to 233a-2 on the other side in the width direction. Incidentally, there is no limitation on the number and positions of the recesses Ra on the end 23R.

In this way, since the recess Ra is provided at the end 23R, the adhesion between the dielectric layers 22 adjacent to each other in the stacking direction at the recess Ra is improved, and peeling can be suppressed more effectively than in a configuration without the recess Ra.

The internal electrode layer 23c is formed as a discontinuous internal electrode pattern with gaps between the regions 230a-1 to 233a-1 and 230a-2 to 233a-2 by a vacuum film formation method such as sputtering. The widths of the gaps are wider than those of the first and second embodiments.

Thereafter, the laminated chip 2 shrinks during the firing step, so that the widths of the gaps between the regions 230a-1 to 233a-1 and 230a-2 to 233a-2 shrink, and the regions 230a-1 to 233a-1 and 230a-2 to 233a-2 are joined together. However, since the widths of the gaps are wide, the gaps are not completely filled, and gaps remain on the side ends 23U and 23D and the end 23R. The remaining gaps are formed as the recesses R and Ra. Incidentally, the manufacturing method of the multilayer ceramic capacitor 1c will be described in detail later.

### Manufacturing Process of Multilayer Ceramic Capacitors

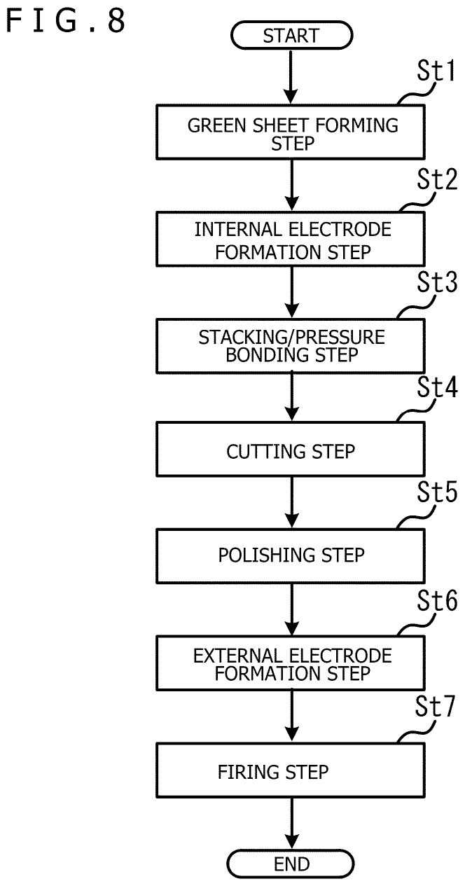

FIG. 8 is a flow chart illustrating an example of the manufacturing process of the multilayer ceramic capacitors 1, and 1a to 1c.

### Green Sheet Forming Step

First, the green sheet forming step Stl is carried out. In this step, a dielectric material obtained by adding various additive compounds (such as sintering aids) to ceramic powder is subjected to wet blending with a binder such as polyvinyl butyral (PVB) resin, an organic solvent such as ethanol or toluene, and a plasticizer. The obtained slurry is used to apply a coating of a dielectric green sheet 7 on a substrate by a die coater method or a doctor blade method, for example, and then dried. The substrate is a PET (polyethylene terephthalate) film, for example.

It should be noted that examples of additive compounds for the ceramic powder include oxides of Mg (magnesium), Mn (manganese), V (vanadium), Cr (chromium), rare earth elements (Y (yttrium), Sm (samarium), Eu (europium), Gd (gadolinium), Tb (terbium), Dy (dysprosium), Ho (holmium), Er (erbium), Tm (thulium), and Yb (ytterbium) ), as well as oxides or glasses of Co (cobalt), Ni, Li (lithium), B (boron), Na (sodium), K (potassium), and Si (silicon).

### Internal Electrode Formation Step

Next, the internal electrode formation step St2 is performed. In this step, a plurality of internal electrode patterns corresponding to the internal electrode layers 23, and 23a to 23c are formed by sputtering on the dielectric green sheet on the substrate, with the patterns spaced apart from each other. Each internal electrode pattern is formed such that the regions 230 to 233, the regions 230-1 to 233-1 and 230-2 to 233-2, the regions 230a to 233a, and the regions 230a-1 to 233a-1 and 230a-2 to 233a-2 are separated by gaps for the above embodiments, respectively. Note that the details of the internal electrode formation step St2 will be described later.

### Stacking/Pressure Bonding Step

Next, the stacking/pressure bonding step St3 is carried out. In this step, dielectric green sheets on which the internal electrode patterns are printed are stacked and is subjected to pressure bonding in the stacking direction to form a laminated sheet. Dielectric green sheets corresponding to the cover layers 20 and 21 are stacked on both end faces of the laminated sheet in the stacking direction.

### Cutting Step

Next, the cutting step St4 is performed. In this step, the laminated sheet after pressure bonding is cut into a plurality of laminated chips 2. For example, the laminated sheet is cut with a blade along a predetermined cut line in the stacking direction to obtain a plurality of laminated chips 2 before firing.

### Polishing Step

Next, the polishing step St5 is performed. In this step, the laminated chip 2 is polished by a method such as barrel polishing. This rounds the corners of the laminated chip 2.

### External Electrode Formation Step

Next, the external electrode formation step St6 is performed. In this step, a conductive paste containing metal powder, glass frit, binder, and solvent, for example, is applied to each of the end faces 2A and 2B, the upper surface 2C, the lower surface 2D, and each of the side surfaces 2E and 2F of the laminated chip 2. After being applied, the conductive paste is dried to form the external electrodes 3a and 3b. Incidentally, the binder and solvent evaporate by baking. Examples of methods for applying the conductive paste include sputtering and dip methods.

### Firing Step

Next, the firing step St7 is performed. In this step, the laminated chip 2 on which the external electrodes 3a and 3b are formed is subjected to a binder removal step in an N₂ atmosphere at 250° C. to 500° C., and then fired in a reducing atmosphere with an oxygen partial pressure of 0.003 (Pa), so that each particle in the laminated chip 2 is sintered. In this manner, the manufacturing process of the multilayer ceramic capacitors 1 and 1a to 1c is performed. Note that, after the firing step, each external electrode 3a and 3b may be coated with a metal such as Cu, Ni, or Sn by plating.

In the above manufacturing process, since the internal electrode pattern corresponding to the internal electrode layer 23 is formed by sputtering, the internal electrode layer 23 can be formed so as to be thinner than when the internal electrode pattern is formed by gravure printing using a metal conductive paste, for example. The method for forming the internal electrode layer pattern will be described below.

### Internal Electrode Pattern of First Embodiment

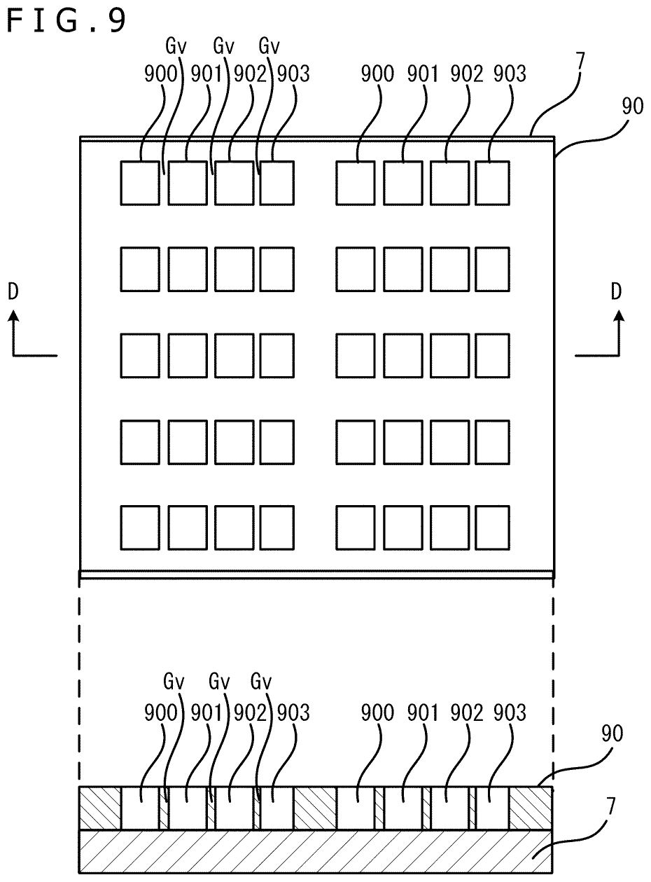

FIG. 9 is a diagram illustrating an example of the dielectric green sheet 7 on which a mask 90 corresponding to the internal electrode patterns of the first embodiment is formed.

The upper part of FIG. 9 illustrates a plan view of the dielectric green sheet 7 and the mask 90, and the lower part illustrates a cross-sectional view of the dielectric green sheet 7 and the mask 90 taken along line D-D in a front view.

The mask 90 has a plurality of mask patterns respectively corresponding to the internal electrode layers 23. The mask 90 is patterned with openings 900 to 903 corresponding to the regions where the regions 230 to 233 of the internal electrode layers 23 are formed. The openings 900 to 903 are partitioned by linear boundaries Gv. After the mask 90 is formed, the dielectric green sheet 7 is subjected to sputtering.

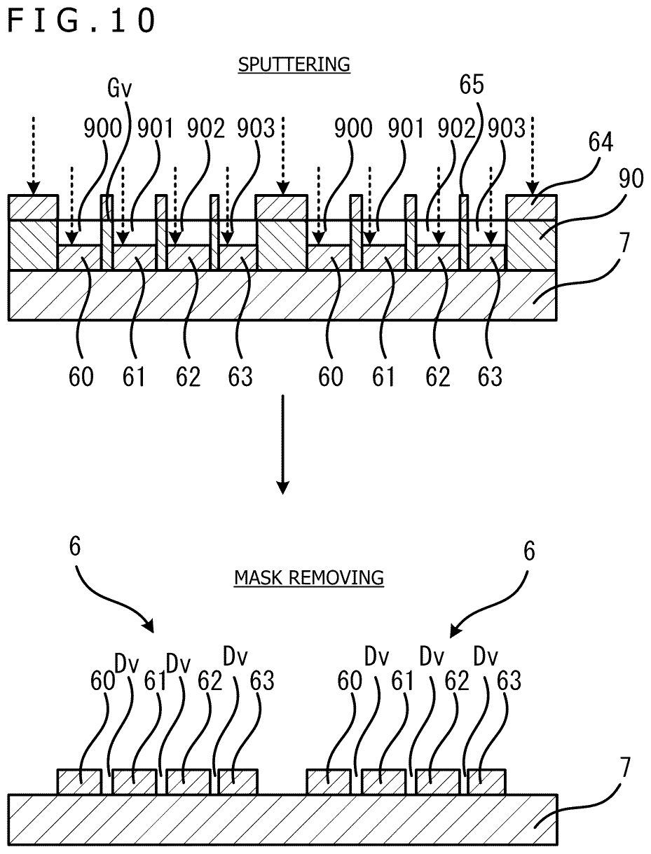

FIG. 10 is a cross-sectional view illustrating an example of how an internal electrode pattern 6 is formed by sputtering. In FIG. 10, the components common to those in FIG. 9 are given the same reference signs, and the description thereof will be omitted.

In the sputtering of the internal electrode formation step St2, metallic atoms of copper or other atoms move toward the dielectric green sheet 7 as indicated by dashed arrows, and are attached on the mask 90 and the dielectric green sheet 7. The mask 90 and the metal films 64 and 65 attached thereon are removed by a lift-off method, for example, and the internal electrode pattern 6 is formed on the dielectric green sheet 7 according to the openings 900 to 903 of the mask 90. The internal electrode pattern 6 includes substantially rectangular regions 60 to 63 partitioned by gaps Dv. The gaps Dv are formed at positions corresponding to the boundaries Gv of the mask 90.

In this manner, in the internal electrode formation step St2, the discontinuous internal electrode pattern 6 having the gaps Dv is formed on the dielectric green sheet 7 by sputtering.

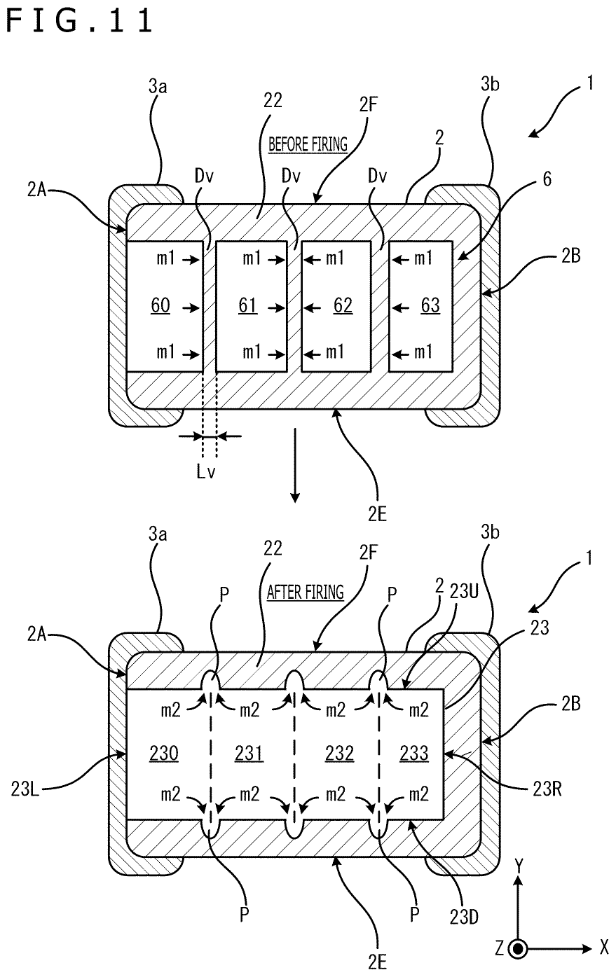

FIG. 11 is a cross-sectional view illustrating the internal electrode pattern 6 before firing and the internal electrode layer 23 after firing in the first embodiment. FIG. 11 illustrates a state in which the internal electrode pattern 6 is viewed from a front in the stacking direction, similarly to FIG. 4. It is to be noted that, in FIG. 11, the same reference signs are used for the components common to those in FIGS. 4 and 10, and the description thereof will be omitted.

The regions 60 to 63 of the internal electrode pattern 6 are spaced apart from one another with the gap Dv therebetween. The regions 60 to 61 may have the same size as each other or sizes different from each other.

In the firing step St7, the laminated chip 2 of the ceramic element assembly shrinks toward its center. Accordingly, the regions 60 to 61 shrink in a direction toward the center as illustrated by arrows m1. The region 60 shrinks toward the adjacent region 61, the region 63 shrinks toward the adjacent region 62, and the regions 61 and 62 shrink to approach each other. As a result, the width of the gap Dv between the regions 60 to 61 shrinks, and the gap Dv is eventually filled.

At this time, at a position of the gap Dv, the regions 60 to 63 of the internal electrode pattern 6 each shrink, and come into contact with each other. Therefore, the contact portions of the regions 60 to 63 are pushed out in the width direction of the multilayer ceramic capacitor 1 as illustrated by arrows m2. This pushed-out portions are formed as the protrusions P after firing. Moreover, the regions 60 to 63 are formed as the regions 230 to 233 of the internal electrode layer 23 after firing.

In this way, in the firing step St7, the laminated chip 2 is fired such that the width of the gap Dv is reduced. Therefore, compared to a case where the internal electrode pattern 6 is formed by sputtering without providing the gap Dv, the stress acting on the internal electrode pattern 6 due to the shrinkage of the laminated chip 2 can be mitigated by ensuring a margin at the gap Dv of the internal electrode pattern 6. Therefore, according to the present embodiment, the occurrence of cracks can be suppressed in the internal electrode pattern 6.

In order to more reliably form the protrusion P, the width Lv of the gap Dv is preferably 15 (μm) or less, and more preferably 10 (μm) or less. Even more preferably, the width Lv of the gap Dv is 5 (μm) or less.

### Internal Electrode Pattern of Second Embodiment

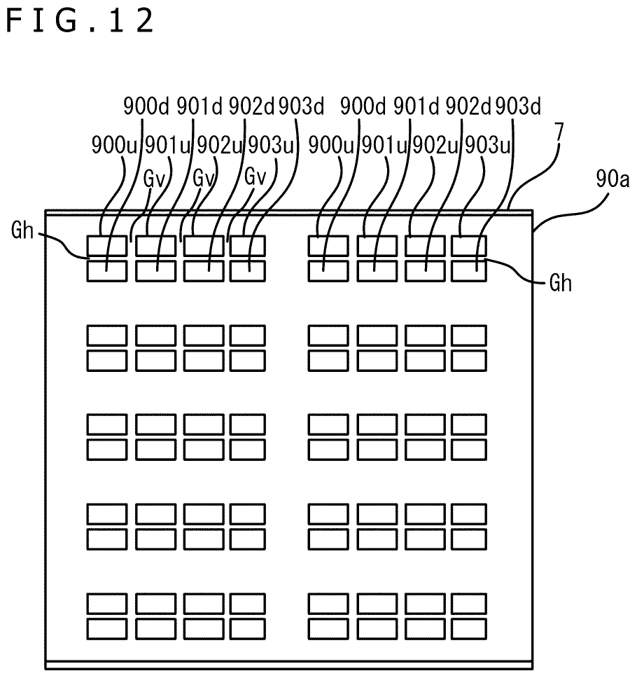

FIG. 12 is a plan view illustrating an example of a dielectric green sheet 7 on which a mask 90a corresponding to the internal electrode patterns of the second embodiment is formed. In FIG. 12, the same reference signs are used for the components common to those in FIG. 9, and the description thereof is omitted.

The mask 90a has a plurality of mask patterns corresponding to the internal electrode layers 23a, respectively. The mask pattern of the present embodiment is formed by adding a linear boundary Gh that is substantially perpendicular to the boundary Gv to the mask pattern of the first embodiment. Therefore, the mask pattern of the present embodiment has eight openings 900u to 903u and 900d to 903d separated by the boundaries Gv and Gh. The openings 900u to 903u and 900d to 903d are patterned so as to correspond to the regions 230-1 to 233-1 and 230-2 to 233-2 of the internal electrode layer 23a.

After the mask 90a is formed, sputtering is performed on the dielectric green sheet 7 in a similar manner to in the first embodiment. In the internal electrode formation step St2, a discontinuous internal electrode pattern having gaps is formed on the dielectric green sheet 7 by sputtering.

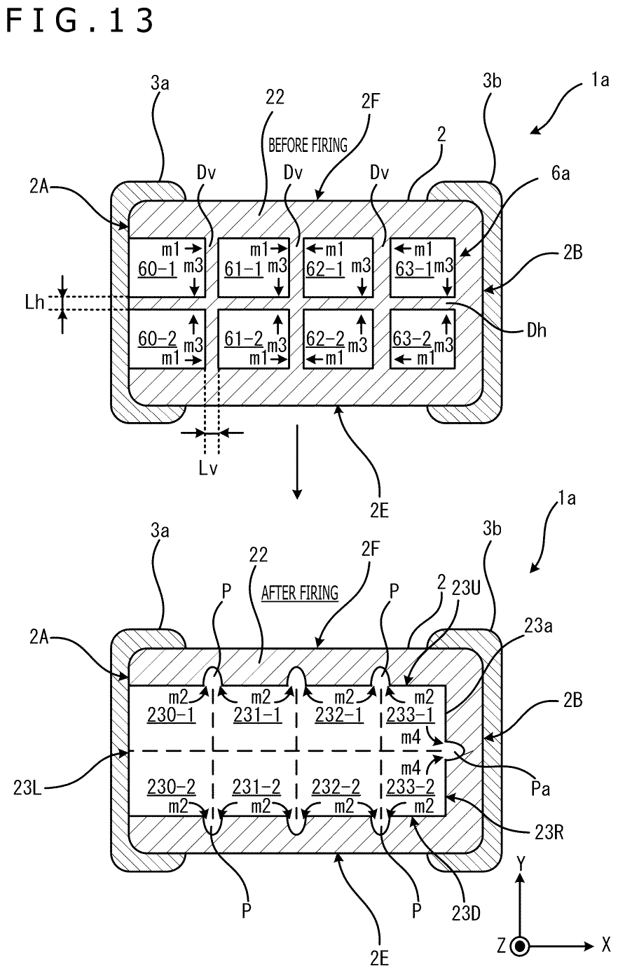

FIG. 13 is a cross-sectional view illustrating an internal electrode pattern 6a before firing and the internal electrode layer 23a after firing in the second embodiment. FIG. 13 illustrates a state in which the internal electrode pattern 6a and the internal electrode layer 23a are viewed from the front in the stacking direction, similarly to FIG. 5. Note that, in FIG. 13, the same reference signs are used for the components common to those in FIGS. 5 and 10, and the description thereof will be omitted.

In the internal electrode pattern 6a of the present embodiment, in addition to the gap Dv similar to that of the first embodiment, a gap Dh extending in a direction substantially perpendicular to the gap Dv is provided. The gaps Dv and Dh are formed at positions corresponding to the boundaries Gv and Gh of the mask 90a, respectively. The internal electrode pattern 6a is divided into eight substantially rectangular regions 60-1 to 63-1, and 60-2 to 63-2 by the gaps Dv and Dh.

The regions 60-1 to 63-1 and 60-2 to 63-2 are formed at positions corresponding to the openings 900u to 903u, and 900d to 903d of the mask 90a, respectively. The regions 60-1 to 63-1 and 60-2 to 63-2 may be the same as or different from each other in size. The regions 60-1 to 63-1 and 60-2 to 63-2 of the internal electrode pattern 6a are spaced apart from each other with the gaps Dv and Dh therebetween.

To be specific, the regions 60-1 to 63-1 are arranged across the gaps Dv in the longitudinal direction of the multilayer ceramic capacitor la, and the regions 60-2 to 63-2 are also arranged across the gaps Dv in the longitudinal direction of the multilayer ceramic capacitor la. The regions 60-1 to 63-1 and the regions 60-2 to 63-2 are arranged across the gap Dh in the width direction of the multilayer ceramic Capacitor 1a.

In the firing step St7, as in the first embodiment, the regions 60-1 to 63-1 and 60-2 to 63-2 shrink toward the center as indicated by the arrows m1. This causes the widths of the gaps Dv between the regions 60-1 to 63-1 and 60-2 to 63- to shrink to finally fill the gaps Dv, and forms the protrusions P as indicated by the arrows m2.

Further, in the firing step St7, the regions 60-1 to 63-1 and the regions 60-2 to 63-2 shrink toward the center so as to approach each other, as illustrated by arrows m3. This causes the width of the gap Dh between the regions 60-1 to 63-1 and 60-2 to 63-2 to shrink, and the gap Dh is eventually filled. At this time, the regions 63-1 and 63-2 come into contact with each other and are pushed out in the longitudinal direction of the multilayer ceramic capacitor 1a, so that the protrusion Pa is formed at the end 23R after firing, as illustrated by arrows m4.

The width Lh of the gap Dh may be the same as or different from the width Lv of the gap Dv.

To more reliably form the protrusion Pa, the width Lv of the gap Dh is preferably 15 (μm) or less, and more preferably 10 (μm) or less. Even more preferably, the width Lv of the gap Dh is 5 (μm) or less.

In this way, the internal electrode pattern 6a is formed to have the gaps Dv and Dh extending in two different directions. Due to this, the stress acting on the internal electrode pattern 6a due to the shrinkage of the laminated chip 2 can be more effectively alleviated by securing a margin not only in the gap Dv but also in the gap Dh extending in a direction different from the gap Dv.

### Internal Electrode Pattern of Third Embodiment

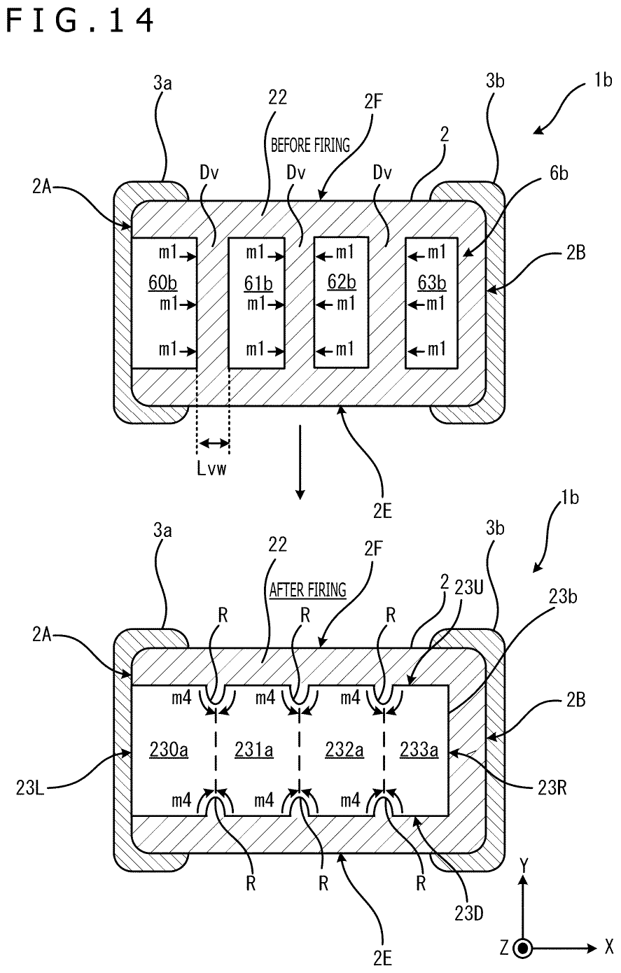

FIG. 14 is a cross-sectional view illustrating an internal electrode pattern 6b before firing and the internal electrode layer 23b after firing in the third embodiment. FIG. 14 illustrates the internal electrode pattern 6b and the internal electrode layer 23b viewed from the front in the stacking direction, similarly to FIG. 6. Note that, in FIG. 14, the same reference signs are used for the components common to those in FIGS. 6 and 11, and their descriptions are omitted.

The internal electrode pattern 6b has regions 60b to 63b arranged across the gaps Dv in the longitudinal direction of the multilayer ceramic capacitor 1b, similarly to the internal electrode pattern 6 of the first embodiment. The regions 60b to 63b are formed by sputtering according to the shapes of the openings 900 to 903 of the mask 90, respectively. Further, the regions 60b to 63b become the regions 230a to 233a of the internal electrode layer 23b, respectively after firing.

In the present embodiment, the width Lvw of the gap Dv is wider than the width Lv of the gap Dv in the first embodiment. Therefore, when the regions 60b to 63b shrink toward the center as illustrated by the arrows m1 during firing, the vicinity of the center of the gap Dv shrinks and fills in as illustrated by the arrows m4, but both ends of the gap Dv in the width direction remain unfilled. This is because the shrinkage force becomes stronger where the center of the laminated chip 2 becomes closer. The remaining portion of the gap Dv is formed as the recess R of the internal electrode layer 23b after firing.

In order to more reliably form the recess R, the width Lvw of the gap Dv is preferably 20 (μm) or more, and more preferably 25 (μm) or more. Even more preferably, the width Lvw of the gap Dv is 30 (μm) or more.

### Internal Electrode Pattern of Fourth Embodiment

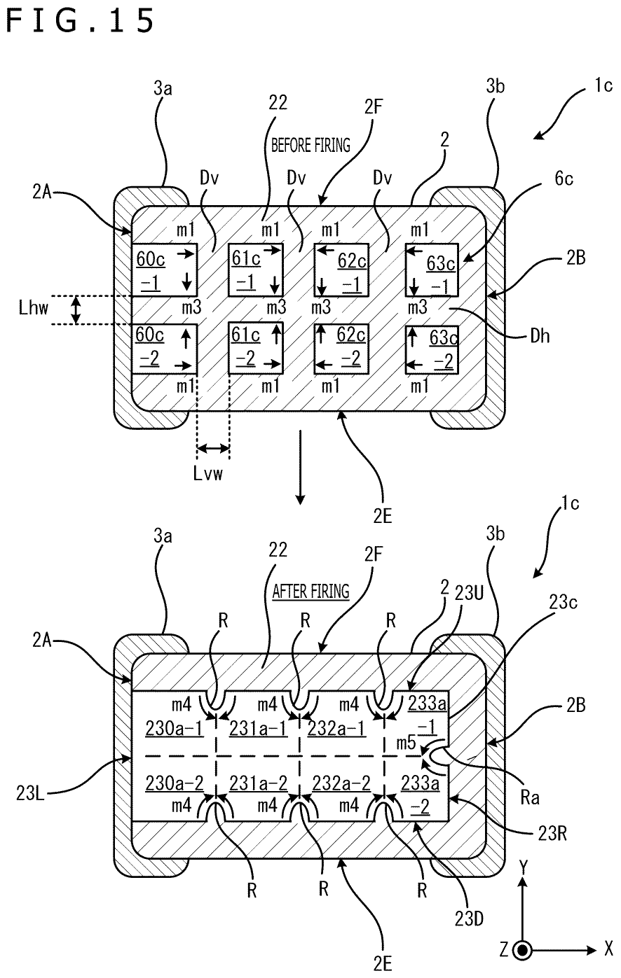

FIG. 15 is a cross-sectional view illustrating an internal electrode pattern 6c before firing and the internal electrode layer 23c after firing in the fourth embodiment. FIG. 15 illustrates the internal electrode pattern 6c and the internal electrode layer 23c viewed from the front in the stacking direction, similarly to FIG. 7. Note that, in FIG. 15, the same reference signs are used for the components common to those in FIGS. 7 and 14, and their descriptions are omitted.

The internal electrode pattern 6c has regions 60c-1 to 63c-1 and 60c-2 to 63c-2 arranged across the gaps Dv in the longitudinal direction of the multilayer ceramic capacitor 1c and the gap Dh in the width direction, similarly to the internal electrode pattern 6a of the second embodiment. The regions 60c-1 to 63c-1 are formed by sputtering according to the shapes of the openings 900u to 903u of the mask 90a, respectively. The regions 60c-1 to 63c-1 become the regions 230a-1 to 233a-1 of the internal electrode layer 23c after firing, respectively. Further, the regions 60c-2 to 63c-2 are formed by sputtering according to the shapes of the openings 900d to 903d of the mask 90a, respectively. The regions 60c-2 to 63c-2 become the regions 230a-2 to 233a-2 of the internal electrode layer 23c after firing, respectively.

In the present embodiment, since the width Lvw of the gap Dv is wider than the width Lv of the gap Dv in the first and second embodiments, the ends of the gap Dv remain unfilled during firing, and the remaining gap Dv is formed as the recess R in the internal electrode layer 23b after firing.

In addition, in the present embodiment, the width Lhw of the gap Dh is wider than the width Lh of the gap Dh in the second embodiment. Therefore, when the regions 60c-1 to 63c-1 and 60c-2 to 63c-2 shrink toward the center as illustrated by the arrows m3 during firing, the vicinity of the center of the gap Dh shrinks and fills in as illustrated by arrows m5, but the end of the gap Dh on the end 23R side in the longitudinal direction remains unfilled. This is because the shrinking force becomes stronger where the center of the laminated chip 2 becomes closer. The remaining part of the gap Dh is formed as the recess Ra of the internal electrode layer 23c after firing. Note that the end of the gap Dh on the opposite end 23L side is connected to the external electrode 3a, so that no recess Ra is formed even after shrinking.

The width Lhw of the gap Dh may be the same as or different from the width Lvw of the gap Dv. In order to more reliably form the recess Ra, the width Lhw of the gap Dh is preferably 20 (μm) or more, and more preferably 25 (μm) or more. Even more preferably, the width Lhw of the gap Dh is 30 (um) or more.

Incidentally, in the above-described embodiments, there is no limitation on the numbers and positions of the gaps Dv and Dh. The numbers and positions of the gaps Dv and Dh can be set by the boundaries Gv and Gh of the masks 90 and 90a.

### Formation of Conductor Thin Film

In each of the above embodiments, depending on the widths of the gaps Dv and Dh or the firing temperature, the gaps Dv and Dh may not be filled sufficiently, and a part of the internal electrode layers 23 and 23a to 23c may not be conductive in the completed multilayer ceramic capacitors 1 and la to 1c. For this reason, the gaps Dv and Dh may be filled in advance with a conductor thin film by sputtering, for example.

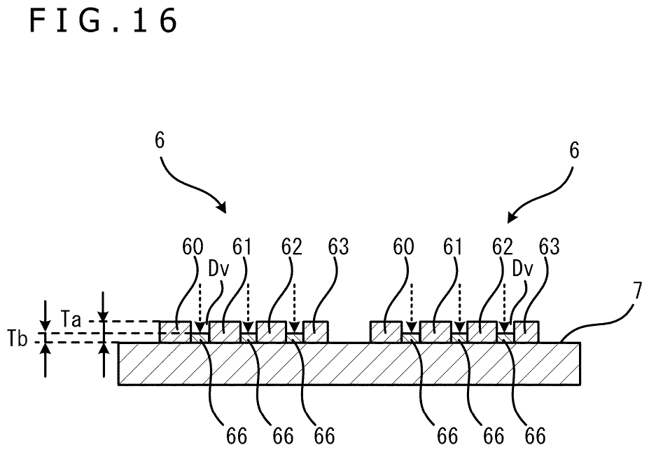

FIG. 16 is a cross-sectional view illustrating an example of a method for forming conductive thin films 66 in the gaps Dv. After removal of the mask 90 illustrated in FIG. 10, the conductive thin films 66 are formed on the gaps Dv by sputtering (see dashed arrows) prior to firing, for example. The conductive thin films 66 are formed of a similar metal material to the internal electrode pattern 6. Therefore, the regions 60 to 63 of the internal electrode pattern 6 are electrically connected by the conductive thin films 66.

Therefore, even when each of the regions 60 to 63 cannot sufficiently shrink during firing, the gap Dv can be filled with the conductive thin film 66, thereby suppressing non-conductivity of the internal electrode layer 23. In this example, the gap Dv is filled, but the gap Dh can also be filled with the conductive thin film 66 in a similar manner. In addition, in the third and fourth embodiments, in order to form the recesses R and Ra at the ends of the internal electrode layers 23b and 23c, sputtering is performed so as not to form the conductive thin film 66 at the positions of the recesses R and Ra. Incidentally, the conductive thin film 66 is an example of a conductive film.

Further, from the viewpoint of suppressing non-conductivity, a thickness Ta of the electrode pattern is preferably at least 7 times, and more preferably at least 8 times a thickness Tb of the conductive thin film 66. More preferably, the thickness Ta of the internal electrode pattern 6 may be at least 9 times the thickness Tb of the conductive thin film 66.

In addition, from the viewpoint of easiness in forming the recesses R of a desired size, the thickness Ta of the electrode pattern is preferably equal to or less than 20 times, and more preferably equal to or less than 15 times the thickness Tb of the conductive thin film 66. More preferably, the thickness Ta of the internal electrode pattern 6 may be equal to or less than 10 times the thickness Tb of the conductive thin film 66.

In each embodiment, the internal electrode patterns 6 and 6a to 6c are formed by sputtering, but the present invention is not limited to this, and other vacuum film formation methods such as a vacuum deposition method and an ion plating method may be used. However, when sputtering is used, it is easier to control the thickness of the internal electrode patterns 6, and 6a to 6c than when using other vacuum film formation methods.

Although the embodiments of the present invention have been described in detail above, the present invention is not limited to the specific embodiments, and various modifications and alterations are possible within the scope of the gist of the present invention described in the claims.

### REFERENCE SIGNS LIST

1, 1a to 1c: Multilayer ceramic capacitor
2: Laminated chip
2A, 2B: End face
2C: Upper surface
2D: Lower surface
2E, 2F: Side surface
3a, 3b: External electrode
6, 6a to 6c: Internal electrode pattern
7: Dielectric green sheet
22: Dielectric layer
23, 23a to 23c: Internal electrode layer
66: Conductive thin film
P, Pa: Protrusion
R, Ra: Recess

1. A method for manufacturing a multilayer ceramic electronic component, the method comprising:
a step of forming an internal electrode pattern that has a gap and is discontinuous, on a dielectric green sheet by a vacuum film formation method;
a step of stacking and applying pressure bonding to a plurality of the dielectric green sheets such that a plurality of the internal electrode patterns overlap each other;
a step of dividing the plurality of dielectric green sheets that have been bonded, into a plurality of laminates; and
a step of firing the laminates such that a width of the gap is reduced.

2. The method for manufacturing the multilayer ceramic electronic component according to claim 1, wherein
the step of forming the internal electrode pattern includes forming the gap having a width of 20 μm or more.

3. The method for manufacturing the multilayer ceramic electronic component according to claim 1, wherein
the step of forming the internal electrode pattern includes forming the gap having a width of 15 μm or less.

4. The method for manufacturing the multilayer ceramic electronic component according to claim 1, wherein
the step of forming the internal electrode pattern includes forming the gap extending in two different directions.

5. The method for manufacturing the multilayer ceramic electronic component according to claim 1, wherein
the step of forming the internal electrode pattern includes forming a conductor film thinner than the internal electrode pattern so as to fill the gap.

6. The method for manufacturing the multilayer ceramic electronic component according to claim 5, wherein
a thickness of the internal electrode pattern is at least seven times a thickness of the conductor film.

7. The method for manufacturing the multilayer ceramic electronic component according to claim 5, wherein
a thickness of the internal electrode pattern is equal to or less than 20 times a thickness of the conductive film.

8. The method for manufacturing the multilayer ceramic electronic component according to claim 1, wherein
the step of forming the internal electrode pattern includes forming the internal electrode pattern by sputtering.

9. A multilayer ceramic electronic component comprising:
a laminate including a plurality of dielectric layers and a plurality of internal electrode layers that face each other with the dielectric layers interposed therebetween; and
a pair of external electrodes that cover a pair of end faces of the laminate that are faced to each other, respectively, and are connected to the plurality of internal electrode layers alternately in a stacking direction of the laminate, wherein
at least one of the plurality of internal electrode layers has one or more recesses or protrusions at a side end extending in a direction in which the pair of end faces face each other in a plan view viewed in the stacking direction.

10. A multilayer ceramic electronic component comprising:
a laminate including a plurality of dielectric layers and a plurality of internal electrode layers that face each other with the dielectric layers interposed therebetween; and
a pair of external electrodes that cover a pair of end faces of the laminate that face each other, respectively, and are connected to the plurality of internal electrode layers alternately in a stacking direction of the laminate, wherein
at least one of the plurality of internal electrode layers has one or more recesses or protrusions at another end that faces an end connected to one of the pair of external electrodes in a plan view viewed in the stacking direction.
